(19) United States
(12) Patent Application Publication
(10) Pub. No.: US 2008/0197669 A1
(43) Pub. Date: Aug. 21, 2008

(54) Module Support For A Motor Vehicle

(76) Inventors: Edward Schleichert, Oberschleissheim (DE); Tilo Schimanski, Landshut (DE)

Correspondence Address: MAGNA INTERNATIONAL, INC., 337 MAGNA DRIVE, AURORA, ON, L4G-7K1, omitted

(21) Appl. No.: 11/817,090

(22) PCT Filed: Feb. 1, 2006
(86) PCT No.: PCT/EP06/00882

§ 371 Date: Aug. 24, 2007

(30) Foreign Application Priority Data
Feb. 25, 2005 (DE) 20-2005-003-080.5

(51) Int. Cl. B62D 29/00

(52) U.S. Cl. 296/181.1

(57) ABSTRACT

According to the invention, a module support (2) for a motor vehicle, comprising a shell-like base structure (1), comprising several shell elements (3,4) of which at least one is provided with at least one accessory component (16), for assembly of or on vehicle parts may be improved, such as to give a rapid production requiring fewer individual working steps with high quality and dimensional accuracy. The above is achieved by a module support for a motor vehicle, comprising a shell-like base structure, comprising several shell elements of which at least one is provided with at least one accessory component for assembly of or on vehicle parts, whereby the accessory component is moulded on at least one of the shell elements.

The invention relates to a module support having the features of the preamble of claim 1.

A crossmember, known from EP 1 298 035 A1, for a motor vehicle of this generic type consists of two half shells connected to one another. A holder is attached to said crossmember by means of welding or adhesive bonding and serves for fastening a steering column, the pedals or other parts. Inside the crossmember, there extends between the tunnel and A-column a tube-like reinforcement, the ends of which are screwed to the crossmember.

Owing to the many individual work steps, for example welding, adhesive bonding, screwing, the production of such a crossmember is complicated and costly. Moreover, these assembly methods require relatively high tolerances. Consequently, the position of individual components in relation to one another may fluctuate markedly, thus considerably hindering the reproducibility of high-quality products.

It is an object of the invention to improve a module support of the type mentioned hereinabove, to the effect that rapid manufacture requiring few individual work steps is possible, along with high quality and good dimensional stability.

This object is achieved in accordance with the invention, by means of a module support having the features of claim 1.

The casting on of the accessory component allows rapid and therefore cost-effective manufacture. The shell element is prefabricated and is then introduced into a casting mold. The accessory component is then cast on with high dimensional stability. Relatively narrow tolerances which are easily reproducible are consequently achieved. If a plurality of accessory components are cast on in one operation, low tolerances of the individual accessory components in relation to one another can be achieved. The module support can be assembled together with other vehicle parts having a relatively perfect fit by means of the cast-on accessory components.

In an advantageous embodiment, at least one shell element may have at least one opening which is filled with casting material from an outside of the shell element to an inside of the shell element. By means of the undercuts which the casting material forms with the wall of the shell element, the stability and positional accuracy of the cast connection are increased.

In a further embodiment of the invention, at least one shell element may have at least two openings which are spaced apart from one another and are distributed over its surface and which are filled with casting material from an outside of the shell element to an inside of the shell element. This increases the stability of the cast connection with the shell element and, consequently, the overall mounting. If appropriate, a stiffening action of the accessory component on the shell element may also result.

In an advantageous embodiment, the casting material may have on an inside of the shell element at least one casting foot engaging behind the wall of the shell element. The casting foot forms an undercut with the shell element and thus ensures stability.

Advantageously, the casting foot may be a positioning point for a component inside the base structure. This facilitates the dimensionally exact attachment of additional components inside the module support.

In a particularly advantageous embodiment of the invention, a supply duct may be held inside the base structure by at least one cast foot. The supply duct is thereby effectively mounted. Under certain circumstances, additional fastening elements for the supply duct may be omitted entirely.

In an advantageous exemplary embodiment of the invention, at least one end opening of the base structure may be formed by at least two shell elements. The opening can be produced easily during the manufacturing process by the shaping of the shell elements. If need be, this facilitates the attachment of components which are to extend through the opening.

In a further embodiment of the invention, at least a portion of the circumference of the base structure may be surrounded by casting material in a ring-like manner. The casting material may in this case extend in the form of a ring over the entire circumference of an approximately tube-like base structure. The width of the ring of casting material is in this case variable. Alternatively, the circumference of an approximately tube-like base structure may also be surrounded by casting material in regions only. The casting material in this case forms an open ring which surrounds the base structure, for example, only by three quarters or only by half. The stability of the module support is thereby increased.

Advantageously, at least one end opening of the base structure may be provided with a cover element which is cast onto the base structure. As a result, an end opening of the base structure is closed and the stability of the module support increased in a single production step.

In an advantageous embodiment of the invention, the base structure may have at least one through-opening which is formed by at least two shell elements. This avoids the need for a further production step for producing the opening, since the edge of the opening consists of a plurality of partial regions which are in each case molded into a shell element. The whole opening is therefore obtained when the individual shell elements are connected.

In a particularly advantageous embodiment of the invention, at least one shell element may have an extension which projects out of the general parting plane of the base structure and extends into a recess in a corresponding shell element. This offset three-dimensional parting plane results in a plurality of advantageous variants for the configuration of the module support, in contrast to a continuous two-dimensional parting plane. If appropriate, the rigidity of the base structure is increased.

The object is achieved, furthermore, by means of a method for producing a module support for a motor vehicle, with an approximately shell-like base structure which is composed of a plurality of shell elements, and at least one accessory component for the assembly of or on vehicle parts on at least one shell element, characterized in that the accessory component is cast onto at least one shell element. A high dimensional stability and a good reproducibility are achieved by means of positioning a shell element in a casting mold and by casting on the accessory components. Owing to the relatively low tolerances which can be achieved in the casting method, the module support can be mounted onto other vehicle parts with a relatively perfect fit by the accessory components. A rapid and cost-effective production method is achieved by means of casting on the accessory components. Remachining steps may be dispensed with, depending on the casting method. Moreover, high dimensional stability and reproducibility are achieved.

In an advantageous embodiment, the shell elements can be assembled only after all the accessory components have been attached to the base structure 1. This sequence of production steps makes it easier to manufacture the overall base structure of the module support.

Advantageously, all the accessory components of a shell element can be produced in a single casting operation. Owing to the simultaneous production of all the accessory components in one casting mold, very low tolerances of the individual accessory components in relation to one another can be achieved.

In a particular embodiment, at least one shell element may be provided with at least one opening, with the result that casting material is distributed from an outside to an inside of the shell element and engages behind the wall of the shell element. By undercuts being made, the connection of the casting material to the shell element is secured and therefore the stability of the connection is increased.

In a further embodiment, at least one shell element may be provided with at least two openings which are spaced apart from one another and are distributed over the circumference and which are filled with casting material from an outside of the shell element to an inside of the shell element. The stability of the casting connection to the shell element is increased by means of distributing multiple openings over the shell element, which may also result, under certain circumstances, in a stiffening of the shell element.

In a further embodiment, the casting material, when it flows through the openings, may form a casting foot on the inside of the shell element. The stability of the casting connection is increased by this undercut.

In an advantageous embodiment of the invention, before the final connection of the shell element, a supply duct is introduced into at least one shell element. The attachment of the supply element thereby becomes substantially easier.

Advantageously, a supply duct may be positioned inside the base structure in relation to at least one casting foot. This makes the mounting of the supply duct easier, since the casting foot forms the reference point for the position of the supply duct.

Advantageously, at least a portion of the circumference of the base structure may be cast around with casting material in a ring-like manner. This increases the stability of the module support.

In a further advantageous embodiment of the invention, at least one end opening of the base structure may be closed by means of a cover element which is cast onto the base structure. As a result, both a closing of the base structure and a reinforcement of the latter are achieved in one production step.

In an advantageous embodiment, the base structure may extend approximately linearly. A higher stability of the module support, for example with respect to intrinsically offset or angled members, is thereby achieved.

Exemplary embodiments of the invention are described below with reference to the following drawings in which:

FIG. 1 shows the module support of a first exemplary embodiment according to the invention in a perspective view from the front, wherein end openings are closed by means of cover elements,

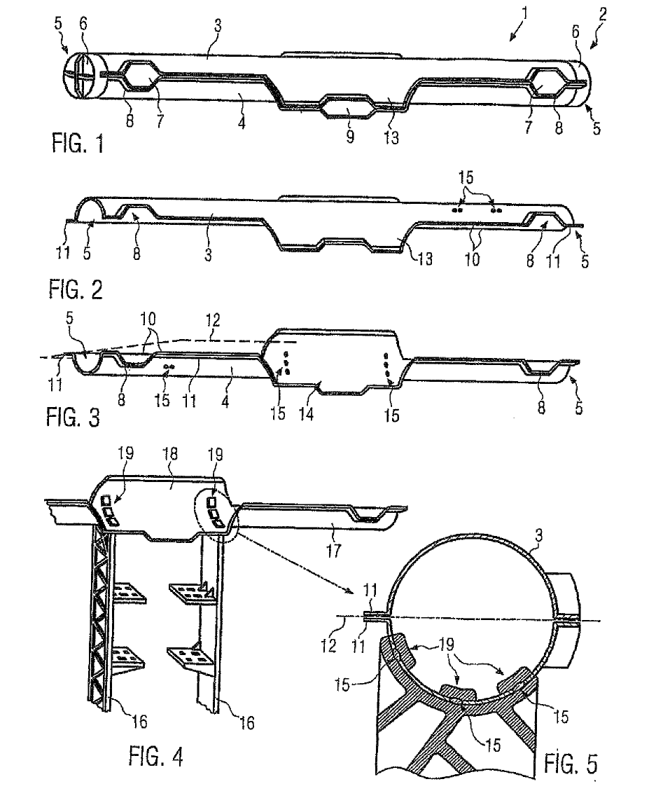

FIG. 2 shows an upper shell element of the base structure of this module support in a perspective view from the front,

FIG. 3 shows a lower shell element of the base structure of this module support in a perspective view from the front,

FIG. 4 shows a lower shell element of the base structure of this module support with two cast-on accessory components in a perspective view,

FIG. 5 shows a sectional illustration of the shell element of FIG. 4 together with the corresponding upper shell element,

FIG. 6 shows a section of an upper shell element of the base structure of this module support with two cast-on accessory components in a perspective view,

FIG. 7 shows a section of a lower shell element of the base structure of this module support with a cast-on accessory component in a perspective view,

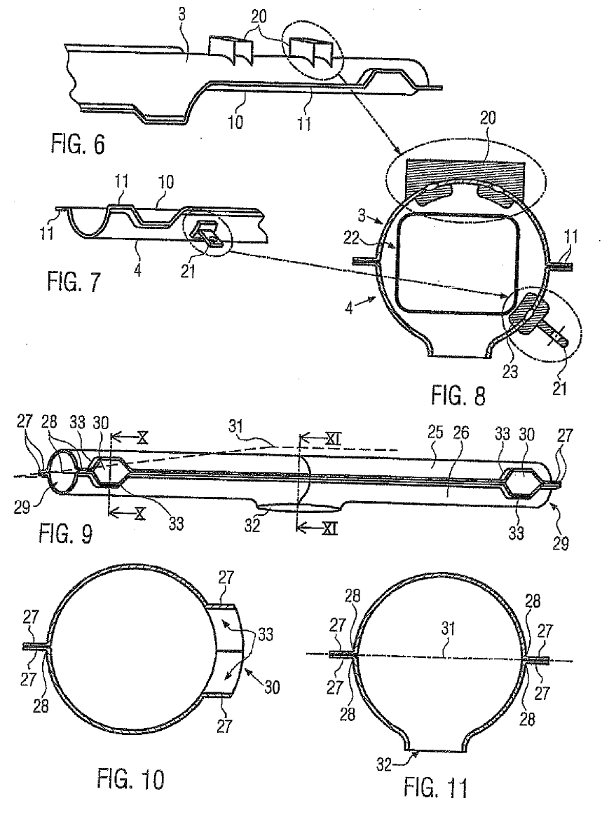

FIG. 8 shows a sectional illustration of the accessory components illustrated in FIGS. 6 and 7, wherein the shell elements are assembled with a supply duct inside the base structure,

FIG. 9 shows a second exemplary embodiment according to the invention of the base structure of the module support in a perspective view from the front,

FIG. 10 shows a cross section through the base structure from FIG. 9, and

FIG. 11 shows a central cross section through the base structure of FIG. 9.

FIGS. 1 to 3 show a base structure 1 of a first exemplary embodiment of a module support 3 according to the invention. The base structure has an upper shell element 3 and a lower shell element 4. The individual shell elements 3 and 4 are of shell-like shape, thus, for example, they are curved. Therefore, a cavity is formed inside the base structure 1 when they are assembled. The base structure 1, in this exemplary embodiment, extends approximately linearly. This means, the mid-axis of the base structure 1 runs approximately straight, i.e. without relevant angled or offset regions. The base structure 1 extends along this axis, the length of the base structure 1 being markedly greater than its width. The shell elements 3, 4 are manufactured from a sheet metal, such as, for example, sheet aluminum or sheet magnesium, or similar materials, preferably by cold or hot forming.

In FIG. 1, end openings 5 of the base structure 1, which occur when the curved shell elements 3, 4 are connected, are closed by means of cover elements 6. These may be manufactured, for example, as a casting, but also from other materials, such as sheet metal or plastic, and, if necessary, are fastened to the base structure 1 preferably by adhesive bonding or welding or by other force-fit or form-fit connection methods. Through-openings 7 and an opening 9 in the middle lower region of the base structure 1 are also only formed when the two shell elements 3, 4 are assembled, by means of bringing together the preformed molded portions 3 in the individual shell elements.

FIG. 2 shows the upper shell element 3 of the base structure 1, which upper shell element is curved, tube-like, over its entire length and has a flange-like molded portion 11 at its two longitudinal edges 10. The lower shell element 4 in FIG. 3, is also of tube-like shape and has a flange-like molded portion 11 at its side edges 10. Along the flange-like molded portion 11, the upper and the lower shell elements 3, 4 can be connected, for example by welding, into a base structure 1, such as is shown in FIG. 1. In addition, the flange-like molded portion 11 acts as stiffening and thus increases the strength of the base structure 1. Since the flange-like molded portion 11 also extends along the molded portions 8, the through-openings 7 are also stiffened in this way.

A general parting plane 12 of the base structure 1 runs as far as possible along the side edges 10 of the shell elements of tube-like shape. Both shell elements 3, 4 have an extension 13 which projects out of the approximately two-dimensional general parting plane and which, upon assembly, extends into a recess 14 of the respective other shell element. The parting plane of the base structure thus has an offset due to this extension 13 and therefore extends three-dimensionally. Owing to the flange-like molded portion 11 which also extends along the side edges of the extension 13, a stiffening of the base structure 1 is achieved here as well. This also includes the opening 9 which occurs only when the extension 13 is inserted into the recess 14.

Moreover, the shell elements 3, 4 have a plurality of openings 15. The distribution of the openings may be selected as desired. In this exemplary embodiment, a total of six openings 15 can be seen, which, spaced apart from one another, are arranged along the tube-like base structure 1, approximately parallel to the side edges 10. The shell element 3 in FIG. 2 has on its rear side openings, not illustrated here, which correspond to the openings 15 on its front side. In addition, six openings 15 are arranged in two rows, each row having three openings, transversely to the side edges 10.

FIG. 4 shows the lower shell element 4 of the base structure 1 with two cast-on accessory components 16. The reference symbols used in FIGS. 1 to 3 designate the same parts as in FIG. 4, and therefore reference is made in this respect to the description of FIGS. 1 to 3. During casting, casting material can penetrate through the openings 15 into the shell element 4 from the outside 17 through the openings 15 onto the inside 18 of the shell element 4 and form one or more casting feet 19 there. By means of this undercut, the connection between the accessory components 16 and the shell element 4 is reinforced.

The cast-on accessory components 16, which are preferably manufactured from an aluminum or magnesium casting material, serve as mountings, for example, as here, for components of the middle console. However, the accessory components 16 may be shaped in any way desired and be provided at any desired point of the base structure 1. They then serve, for example, as mountings for the instrument panel and further components such as, for example, tunnel supports or frequency struts. The module support 2 can then, for example, connect the two A-columns of a motor vehicle to one another.

FIG. 5 shows a section through the shell element and one of the cast-on accessory components 16 of FIG. 4. The reference symbols used in FIGS. 1 to 4 designate the same parts as in FIG. 5, and therefore reference is made in this respect to the description of FIGS. 1 to 4. The adaptation of the casting material to the outside 17 and the shell element 4 can be seen in sectional view. The casting material has penetrated through the openings 15 and forms casting feet 19 on the inside 18 of the shell element 4. The undercut which the casting material forms with the shell element 4 secures and reinforces the connection between the shell element 4 and the accessory component 16.

FIGS. 6 to 8 show further cast-on accessory components 20, 21 on the shell elements 3, 4 in a perspective illustration and in a sectional illustration. The reference symbols used in FIGS. 1 to 5 designate the same parts as in FIGS. 6 to 8, and therefore reference is made in this respect to the description of FIGS. 1 to 5. FIG. 6 shows the upper shell element 3 with two further cast-on accessory components 20. FIG. 7 shows the lower shell element 4 with a single further cast-on accessory component 21. During casting, the casting material of the accessory components 20 and 21 mates with the outer contour of the respective shell element 3 or 4. The casting material may in this case surround the circumference of the shell element to a greater or lesser extent. The contact surface can be kept small by means of anchoring the accessory component with the shell element via casting feet. Thus, for example, an accessory component 21 may also be anchored with the aid of a casting foot 23. Casting material can thereby be saved, with the result that the overall weight of the module support is also reduced.

FIG. 8 shows the shell elements from FIGS. 6 and 7 in the assembled state and in sectional view. The sectional plane is in this case drawn through one of the accessory components 20 and through the accessory component 21. A supply duct 22 can also be seen in sectional view, which is introduced into a shell element preferably before the assembly of the shell elements. The supply duct, which is manufactured as a blow molding or as a foam molding, may, however, also be introduced into the base structure 1 only after the shell elements 3, 4 have been assembled into the latter. In this exemplary embodiment, the casting foot 23 of the accessory component 21 serves for positioning the supply duct 22. Advantageously, the supply duct 22 may also be held inside the base structure 1 by means of a plurality of casting feet, so that a very good positioning and securing of the supply duct 2 takes place, with the result that additional fastening elements of the supply duct 2 may, under certain circumstances, be dispensed with. Alternatively, instead of the supply duct 22, simply a switching device, for example, a switching plate, may also be provided in the base structure 1. This is appropriate, for example, in the case of routing an air flow through the base structure 1.

FIGS. 9 to 11 show a second exemplary embodiment of the invention, in which the base structure 1 of the module support 2 is likewise formed from two shell elements. In this exemplary embodiment, too, the shell elements 25, 26 consist of sheet metal, preferably sheet aluminum or sheet magnesium, or of a similar material and are preferably manufactured by cold or hot forming. The upper shell element 25 is connected, here too, to the lower shell element 26 via flange-like molded portions 27 which extend along the side edges 28 of the shell elements 25, 26. Both shell elements are together of tube-like shape and, similarly to the first exemplary embodiment, form end openings 29 and through openings 30 when they are joined. The overall base structure 1 is stiffened by means of the flange-like molded portions 27.

Here too, a parting plane 31 extends along the flange-like molded portion 27, but, in contrast to the first exemplary embodiment is not intrinsically offset, but is of purely two-dimensional design. As a result, the opening 32 in the middle of the base structure 1 also does not fall into the parting plane 31, but, instead, has to be provided in the lower shell element 26 during manufacture.

FIG. 10 shows a section of the base structure 1 from FIG. 9 through one of the through-openings 30. The through-openings 30 occur during the assembly of the two shell elements 25, 26 as a result of the meeting together of molded portions 33 in the upper and the lower shell elements 3, 4. The through-openings 30 are stiffened by means of the flange-like molded portions 27 which also extend along the molded portions 33.

FIG. 11 shows a central sectional view through the tube-like base structure 1 of the module support 2 of FIG. 9. Since, in this exemplary embodiment, the parting plane 31 runs purely two-dimensionally, the lower shell element 26 has provided in it an opening 32 through which, for example, further components, such as a supply duct, can be led downward out of the module support.

In this second exemplary embodiment, too, accessory components 16 similar to FIGS. 4 and 5 and accessory components similar to FIGS. 6 to 8 may be provided, which are not shown here for the sake of illustration. Likewise, similar openings 15 and cover elements 5 may also be provided in this exemplary embodiment. Here, too, similarly to the first exemplary embodiment, a supply duct and/or a switching device may be provided inside the base structure 1.

A method for producing a module support for a motor vehicle is explained below with reference to the exemplary embodiments illustrated in the figures.

A shell element 3, which preferably consists of sheet metal, such as, for example, sheet aluminum or sheet magnesium, steel or any other material, is manufactured, for example, by cold or hot forming. It thereby acquires its shell-like curved shape. Moreover, in this previous work step, the openings 15 and 9 or 32, the molded portions 8 and the flange-like molded portion 11 are produced. The preformed shell element 3 is then introduced into a casting mold and is provided by casting with accessory components 16. The accessory components are preferably manufactured from an aluminum or magnesium casting material. In the casting method, for example aluminum diecasting, the casting material flows through the openings 15 from an outside 17 to an inside 18 of the shell element 3 and on the inside 18 of the shell element forms a plurality of casting feet 19, as can be seen clearly in FIG. 4. The stability of the connection between the accessory component 16 and the shell element 3 is thereby increased. If need be, the accessory component 16 can also exert a stiffening action on the shell element 3 by means of arranging the casting material on the outside 17 of the shell element 3 and by anchoring the casting material on the openings 15 and casting feet 19.

After the lower shell element 4 has also been manufactured in a similar way, the two shell elements 3, 4 can be assembled and connected to one another along the flange-like molded portion 11, for example by adhesive bonding or welding, to form the base structure 1. The base structure 1 or the module support 2 is thereby further stiffened. If the supply duct 25 is to be provided inside the base structure 1, this supply duct may be premounted in a shell element before the two shell elements are connected. In this case, it can be positioned in relation to the cast feet 19. However, the supply duct 22 manufactured as a blow molding or foam molding may also be inserted into the base structure 1 only after the assembly of the shell elements 3, 4. Alternatively or additionally to the supply duct 22, a switching device, such as, for example, a switching plate, may also be mounted inside the base structure 1. This is preferably premounted on a shell element 3 before final assembly.

As shown in FIG. 1, the end openings 5 of the base structure 1 thus obtained may be closed by means of cover elements 6. To secure these cover elements 6, they may be welded or adhesively bonded to the base structure 1. A reinforcement of the whole module support is thereby achieved at the same time.

In order to reinforce the base structure 1 even further at least a portion of the whole circumference of the base structure 1 may also be cast around with casting material in a ringlike manner in other places. The casting material may in this case be applied in the form of a ring over the entire circumference of the approximately tube-like base structure. The width of this casting material ring is variable. Alternatively, the circumference of the base structure 1 may also be cast around only by three quarters or by half, that is to say in the form of a semicircle, so that the ring of casting material is not completely closed.

1. A module support (2) for a motor vehicle, with a shell-like base structure (1) having a plurality of shell elements (3, 4)1 at least one of which is provided with at least one accessory component (16) for assembly of or on vehicle parts, the accessory component (16) being cast on at least one of the shell elements (3, 4), characterized in that the casting material has, on an inside of the shell element (18), at least one casting foot (19) engaging behind the wall of the shell element.

2. The module support (2) as claimed in claim 1, characterized in that at least one shell element (3, 4) has at least one opening (15) which is filled with casting material from an outside (17) of the shell element (3, 4) to an inside (18) of the shell element (3, 4).

3. The module support as claimed in at least one of the preceding claims, characterized in that at least one shell element (3, 4) has at least two openings (15) which are spaced apart from one another and are distributed over its surface and which are filled with casting material from an outside of the shell element (17) to an inside of the shell element (18).

4. The module support (2) as claimed in at least one of the preceding claims, characterized in that the casting foot (19) is a positioning point for a component inside the base structure (1).

5. The module support (2) as claimed in at least one of the preceding claims, characterized in that a supply duct (22) is held inside the base structure (1) by at least one casting foot (19).

6. The module support (2) as claimed in at least one of the preceding claims, characterized in that at least one end opening (5) of the base structure (1) is formed by at least two shell elements (3, 4).

7. The module support (2) as claimed in at least one of the preceding claims, characterized in that at least a portion of the circumference of the base structure (1) is surrounded by a casting material in a ring-like manner.

8. The module support (2) as claimed in at least one of the preceding claims, characterized in that at least one end opening (5) of the base structure (1) is provided with a cover element (6) which is cast onto the base structure (1).

9. The module support (2) as claimed in at least one of the preceding claims, characterized in that the base structure (1) has at least one through-opening (7) which is formed by at least two shell elements (3, 4).

10. The module support (2) as claimed in at least one of the preceding claims, characterized in that at least one shell element (3, 4) has an extension (13) which projects out of the general parting plane (12) of the base structure (1) and extends into a recess (14) in a corresponding shell element (3, 4).

11. The module support (2) as claimed in at least one of the preceding claims, characterized in that the base structure (1) extends approximately linearly.

12. The module support (2) as claimed in at least one of the preceding claims, characterized in that the casting material is a metal or a metal alloy.
